(19) United States
(12) Patent Application Publication
(10) Pub. No.: US 2008/0002394 A1
(43) Pub. Date: Jan. 3, 2008

(54) Lighted clipboard with storage compartment

(76) Inventor: Roger G. Jones, Dayton, OH (US)

Correspondence Address: GEORGE F. HELFRICH, 162 SHASTA DRIVE, NEWPORT NEWS, VA, 23608, US

(21) Appl. No.: 11/480,665

(22) Filed: Jul. 3, 2006

(51) Int. Cl. F21V 33/00

(52) U.S. Cl. 362/99; 362/154

(57) ABSTRACT

A portable, lighted clipboard includes an elongated, substantially rigid and flat writing tablet, which forms the top of a chamber having a front and a back wall and 2 side walls. The chamber is closed when the writing tablet, which is hingedly mounted at the top thereof on the front wall of the chamber, is allowed to swing to a position contacting the side and back walls of the chamber. An open chamber is presented when the writing tablet is allowed to swing free of contact with the side and back walls of the chamber. A housing, located on the exterior surface of the writing tablet near the top thereof, houses a device, such as a battery-operated fluorescent lamp, to provide illumination, which illumination is directed by the housing along the entire length of the exterior surface of the writing tablet. A hinged clip or the like is attached to the exterior surface of the writing tablet below the housing for holding documents in place on the writing tablet. Documents which have been worked on, or are to be worked on, are stored in the compartment.

### BACKGROUND OF THE INVENTION

1. Field of the Invention

This invention relates generally to clipboards. It relates particularly to a specially illuminated portable clipboard which includes a storage compartment.

2. Description of Related Art

Portable, illuminated clipboards are known in the art. As examples, the following U.S. patents are cited: 5,502,623 and 5,607,223. Howsoever efficacious, the portable, illuminated clipboards of the art are found wanting, in that (1) they are complicated and expensive devices which lack durability and fall easily into a state of disrepair; (2) they do not effectively, efficiently, and economically provide for illumination along the entire length of a document to be written upon, filled in, drawn upon or painted upon; and (3) they do not provide an accompanying, integral compartment for convenient storage of documents worked on and/or to be worked on.

### BRIEF SUMMARY OF THE INVENTION

It is the primary object of the present invention to provide what is not available in the art, viz., an uncomplicated, inexpensive, portable clipboard which is durable, does not easily fall into a state of disrepair, and which does effectively, efficiently, and economically provide for illumination along the entire length of a document to be written upon, filled in, drawn upon, or painted upon, while concurrently providing an accompanying, integral compartment for convenient storage of documents worked on and/or to be worked on.

This primary object and its attending benefits are achieved by providing a portable clipboard which includes an elongated, substantially rigid and flat writing tablet, which tablet forms the top of a chamber, which has front and back walls and 2 side walls. The writing tablet is hingedly mounted at the top thereof on the front wall of the chamber. The chamber is completely closed when the writing tablet is allowed to swing to a position contacting the side walls and the back wall of the chamber. The chamber is open when the writing tablet is allowed to swing free of contact with the side walls and the back wall of the chamber. A housing is located on the exterior surface of the writing tablet near the top thereof. The housing partially covers a device which provides illumination, such as a battery-operated fluorescent lamp. Illumination from the lamp is directed by the housing along the entire length of the exterior surface of the writing tablet. Documents to be worked on are held in place on the writing tablet by means of a hinged clip or the like, which is secured to the exterior surface of the writing tablet below the housing. Documents which have been worked on, or are to be worked on, are kept in the compartment.

### BRIEF DESCRIPTION OF THE SEVERAL VIEWS OF THE DRAWINGS

For a more complete understanding of the present invention, including its primary object and attending benefits, reference should be made to the Detailed Description of the Invention, which is set forth below. This Detailed Description should be read in the light of the accompanying Drawings, wherein:

FIG. 1 is a perspective view, schematically picturing a preferred embodiment of the present invention in the “closed” configuration thereof;

FIG. 2 is a perspective view, schematically picturing the preferred embodiment of FIG. 1 in the “open” position;

FIG. 3 is a schematic plan view of the embodiment shown in perspective in FIG. 1;

FIG. 4 is a schematic bottom view of the embodiment of FIG. 1;

FIG. 5 is a schematic right side elevation of the embodiment of FIG. 1;

FIG. 6 is a schematic left side elevation of the embodiment of FIG. 1;

FIG. 7 is a schematic rear elevation of the embodiment of FIG. 1; and

FIG. 8 is a schematic front elevation of the embodiment of FIG. 1.

### DETAILED DESCRIPTION OF THE INVENTION

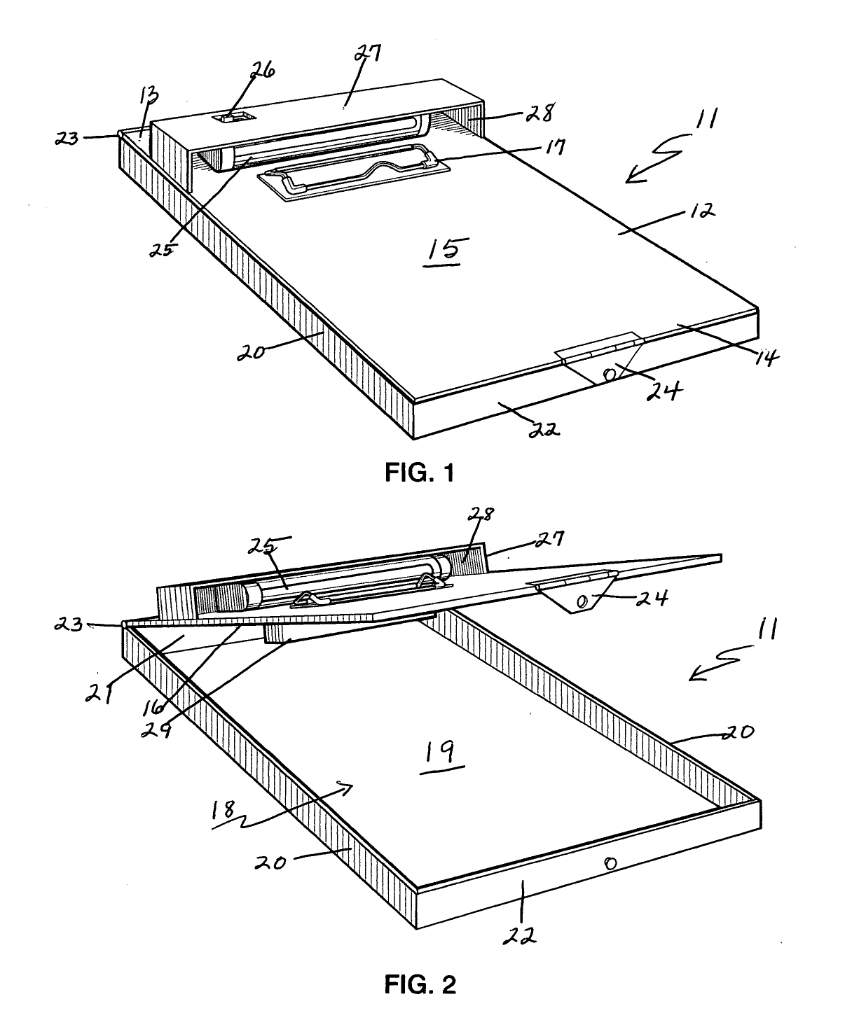

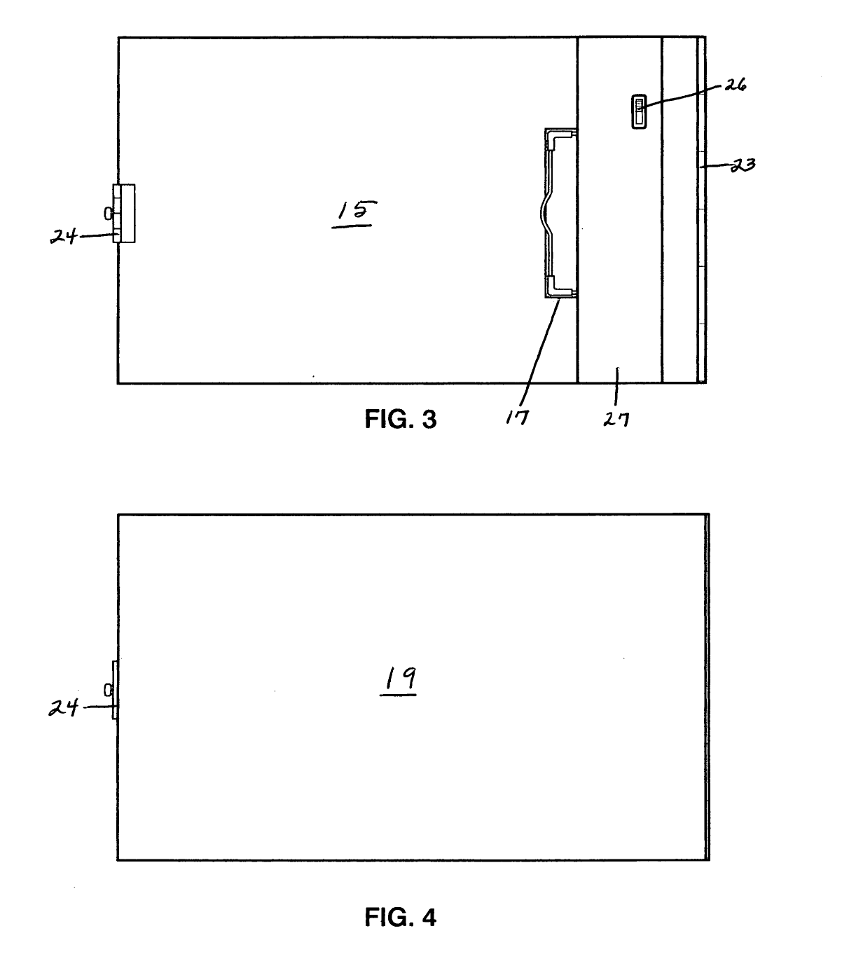

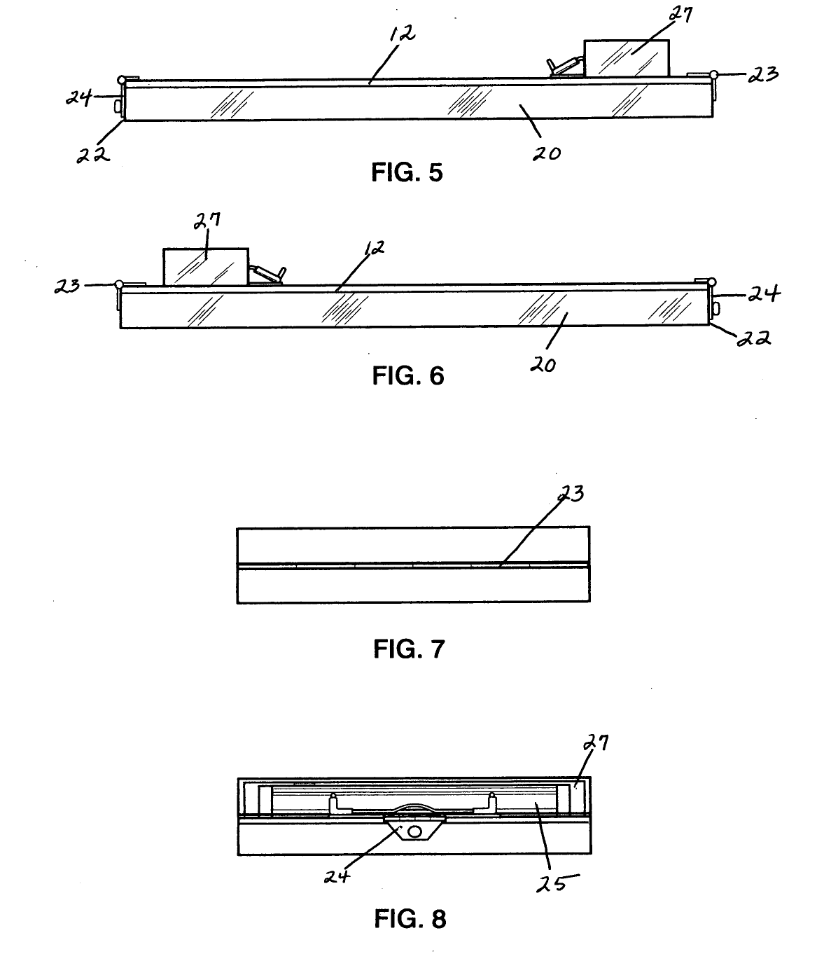

Referring now to the Drawings, FIG. 1 shows a preferred embodiment 11 of the present invention in its “closed” configuration, i.e., in the configuration thereof which is ready for immediate employment by a user for reading, writing, drawing, or otherwise working on a document at night or in a darkened space. The present invention is especially suitable for use by policemen, security guards, nurses, other health professionals, airline pilots, military corpsmen in the field, newspaper reporters, artists and the like, who frequently read and write, paint, or fill in forms, away from lighted rooms and offices. Embodiment 11 includes an elongated, substantially quadrangular, rigid, and flat writing tablet 12, which is conveniently fabricated from a wide variety of materials of construction such as wood, rigid plastics, polymeric composites, and metals, among others. Writing tablet 12 has a top end 13, a bottom end 14, an outer surface 15, and an inner surface 16. (See FIG. 2.)

Located on outer surface 15 and secured thereon is a means for holding documents in place on writing tablet 12. This means is conveniently a hinged clip 17, among other equivalent means known to the skilled artisan.

Referring now in particular to FIG. 2, embodiment 11 includes an elongated, substantially quadrangular open compartment 18, which has an elongated, substantially quadrangular bottom panel 19, which is attached to two elongated, perpendicular side walls 20, a perpendicular front wall 21 and a perpendicular back wall 22. Bottom panel 19, as well as side walls 20, front wall 21 and back wall 22 are conveniently fabricated from the same materials of construction as writing tablet 12. Writing tablet 12 and bottom panel 19 have the same dimensions, i.e., they are coextensive with each other. Common sizes are standard letter size and standard legal size. Of course, many other sizes may be employed as desired. The height of walls 20, 21, and 22 may vary, of course as desired, as a major purpose of compartment 18 is to contain documents which have been worked on, and/or which will be worked on. Convenient heights vary between 1 and 3 inches.

Referring now to all of the FIGS., writing tablet 12 is hingedly mounted 23 at its top end 13 to front wall 21 of the compartment 18, so that an enclosed chamber is presented when writing tablet 12 is allowed to swing to a position contacting side walls 20 and back wall 22 of compartment 18. A means for releasably fastening bottom end 14 of tablet 12 to back wall 22 of compartment 18 is provided. Such a means is conveniently latch 24, among other equivalent releasably fastening means known to the skilled artisan.

An illuminating means, shown here as a battery powered fluorescent lamp 25 is provided to illuminate documents held in place on writing tablet 12 by means of hinged clip 17. As is understood by the skilled artisan, other equivalent illuminating means may be employed. Such a battery powered fluorescent lamp 25 is conveniently and advantageously employed, as the batteries thereof may be conveniently recharged in the home employing a battery charger pack, or in an automobile, employing the same such pack which is adapted for use with a cigarette lighter. Battery powered fluorescent lamp 25 or equivalent means is secured to exterior surface 15 of writing tablet 12 in a transverse position across writing tablet 12, as shown. An on-off switch 26 is provided for convenience in employing fluorescent lamp 25.

A substantially quadrangular housing 27 contains fluorescent lamp 25, the housing 27 being closed at the top thereof and all sides thereof, except that side thereof which faces bottom end 14 of writing tablet 12. Hinged clip 17 is preferably secured on upper surface 15 of writing tablet 12, at a position below the fluorescent lamp 25, which is contained within housing 27. Housing 27 in combination with fluorescent lamp 25 concentrates and directs illumination along the entire length of a document which is held in place on upper surface 15 of writing tablet 12 by means of hinged clip 17. This is especially advantageously accomplished when the interior 28 of housing 27 is covered with a reflective material, such as a reflective paint or a reflective metal foil such as aluminum foil, among other equivalent reflective materials know to the skilled artisan.

Beneficial results are provided if the present invention also includes means for holding in place within compartment 18 documents to be worked on, and/or those already worked on. As an example of such means is resilient crossbar 29, which is attached to bottom surface 16 of writing tablet 12 and comes to rest on top of documents stored in compartment 18 when the present invention is in its “closed” configuration.

A handle (not shown) may be provided at any convenient location on the exterior of the present invention (e.g. on the exterior of front wall 21 or the exterior of bottom wall 22) to facilitate the transportation of the present invention from place to place.

Also advantageously employed is one or more writing, drawing, or painting implement holders (not shown) which may be positioned at various locations within compartment 18.

What is claimed is:

1. A portable, lighted clipboard, comprising:
a. an elongated, substantially quadrangular, rigid, and flat writing tablet having a top end, a bottom end, an outer surface and an inner surface;
b. an elongated, substantially quadrangular open compartment comprising an elongated, substantially quadrangular bottom panel, which is attached to two elongated, perpendicular side walls, a perpendicular front wall and a perpendicular back wall, the writing tablet being of the same shape and size as the bottom panel of the open compartment; the writing tablet being hingedly mounted at its top end to the front wall of the open compartment so that an enclosed chamber is presented when the writing tablet is allowed to swing to a position contacting the side walls and the back wall of the open compartment, and an unenclosed chamber is presented when the writing tablet is allowed to swing free from contact with the side walls and the back wall of the open compartment;
c. Illuminating means located at the top of the writing tablet on the exterior surface thereof to provide illumination along the length of the writing tablet;
d. a substantially quadrangular housing for containing the illuminating means, the housing being open on the side thereof facing the bottom end of the writing tablet, and closed at the top thereof and all remaining sides thereof, so that illumination is directed along the entire length of the writing tablet; and
e. means attached to the exterior surface of the writing tablet and positioned thereon below the illuminating means, for holding documents in place on the writing tablet.

2. The clipboard of claim 1, wherein the writing tablet is a flat sheet of a member selected from the group consisting of wood, plastics, polymeric composites, and metals.

3. The clipboard of claim 1, wherein the means for holding documents in place on the writing tablet is a hinged clip.

4. The clipboard of claim 1, which additionally comprises means for releasably fastening the bottom end of the writing tablet to the back wall of the open compartment.

5. The clipboard of claim 1, wherein the illuminating means is a battery operated fluorescent lamp.

6. The clipboard of claim 5, wherein the fluorescent lamp is fastened to the exterior surface of the writing tablet in a transverse position across the writing tablet.

7. The clipboard of claim 5, wherein the inside of the housing is covered with a reflective material.

8. The clipboard of claim 7, wherein the reflective material is a metal foil.

9. The clipboard of claim 8, wherein the metal foil is aluminum foil.

10. The clipboard of claim 1, which additionally comprises means attached to the bottom surface of the writing tablet for holding documents in place on the bottom panel.
